(19) United States
(12) Patent Application Publication
(10) Pub. No.: US 2009/0282165 A1
(43) Pub. Date: Nov. 12, 2009

(54) Communication System for a Control System Over Ethernet and IP Networks

(75) Inventor: Francois Jammes, Corenc (FR)

Correspondence Address: SCHNEIDER ELECTRIC / SQUARE D COMPANY;LEGAL DEPT. - I.P. GROUP (B&W), 1415 S. ROSELLE ROAD, PALATINE, IL, 60067, US

(73) Assignee: Square D Company, Palatine, IL (US)

(21) Appl. No.: 12/419,695

(22) Filed: Apr. 7, 2009

Related U.S. Application Data
(63) Continuation of application No. 09/623,689, filed on Sep. 6, 2000, now abandoned.
(60) Provisional application No. 60/078,223, filed on Mar. 16, 1998.

(51) Int. Cl. G06F 15/173

(52) U.S. Cl. 709/236

(57) ABSTRACT

A communication system is provided for communication within a control system. The communication system has a plurality of simple devices connected to an intra-level communications network, each simple device being adapted to directly exchange data with the other simple devices. The communications system also has at least one intelligent device connected to the intra-level communications network, each intelligent device being adapted to directly exchange data with each simple device on the intra-level communications network. The communication system can have a plurality of intra-level communications networks. The intra-level communications networks can be directly connected by an intra-level core connector or by an inter-level core connector through an inter-level network of the intelligent devices

### RELATED APPLICATIONS

This application is a continuation of U.S. application Ser. No. 09/623,689 filed Sep. 6, 2000, which is a 371 national stage of PCT/US99/05675 filed Mar. 15, 1999, which claims the benefit of U.S. Provisional Application No. 60/078,223, filed Mar. 16, 1998.

### TECHNICAL FIELD

The present invention generally relates to an industrial automation system for monitoring and controlling field devices within a distributed digital control system. More specifically, the present invention relates to communication networks and protocols for real time communication between and among simple devices, intelligent devices, as well as other devices.

### BACKGROUND

The use of Ethernet-Internet Protocol (IP) networks is very large within applications in the Information Technology field. Up to now, in industrial control and automation applications, Ethernet-IP networks have been used mainly to transfer non time-critical information.

For example, although the HP Ventera range of products uses a publisher/subscriber relationship integrated in the Tibco protocol, the HP Ventura is not optimized for real time automation applications, e.g., not providing any timeliness of published data.

### SUMMARY OF THE INVENTION

The present invention is a Distributed Data solution for industrial control over Ethernet-IP networks. The purpose of this invention is to provide means to transfer over Ethernet-IP network time-critical information between devices participating in a large industrial control or automation solution. Known technology includes the Client/Server relationship using Modbus (PI-MBUS-300) or other traditional messaging application layer protocol. The present invention, by using publisher/subscriber relationship, IP multicasting and broadcasting solutions, and data validation means using timeliness statuses, provides better performance, low cost of devices using this solution, as well as capability for direct communication between devices. Moreover, performance achieved with this solution answers the needs of the most demanding real-time automation applications. In addition, the simplicity of the solution provides capability to integrate it in simple and low cost devices. Furthermore, direct communication between devices reduces the cost of the global application.

This present invention can, therefore, be used in all applications where traditional device buses or field buses are used today (for example, DeviceNet, ControlNet, Fieldbus Foundation, Profibus, Modbus+, Word1FIP, Interbus-S, etc.). Applications of the present invention can include, for example, Industrial Control, Automation, Process Control, Electrical Distribution, Building Automation, and other applications.

In accordance with the present invention, a communication system is provided for communication within a control system. The communication system has a plurality of simple devices connected to an intra-level communications network, each simple device being adapted to directly exchange data with the other simple devices. The communications system also has at least one intelligent device connected to the intra-level communications network, each intelligent device being adapted to directly exchange data with each simple device on the intra-level communications network. The communication system can have a plurality of intra-level communications networks. The intra-level communications networks can be directly connected by an intra-level core connector or by an inter-level core connector through an inter-level network of the intelligent devices.

Other advantages and aspects of the present invention will become apparent upon reading the following description of the drawings and detailed description of the invention.

### BRIEF DESCRIPTION OF THE DRAWINGS

FIG. 1 is a block diagram of an intra-level communications network of the present invention.

FIG. 2 is a block diagram of the intra-level communications network of FIG. 1 having multiple intelligent devices therein.

FIG. 3 is a block diagram of an inter-level communications network of the present invention.

FIG. 4 is a block diagram of multiple intra-level communications networks connected through an intra-level core connection of the present invention.

FIG. 5 is a block diagram of multiple intra-level communications networks connected through an inter-level core connection of the present invention.

FIG. 6 is a block diagram of multiple intra-level communications networks connected through an intra-level core connection, depicting additional connections to other devices and networks of the present invention.

FIG. 7 is a block diagram of real time distributed data base (RTDDB) connections of devices on a single cluster of the present invention.

FIG. 8 is a block diagram of multiple intra-level communications networks connected through an inter-level core connection and through an intra-level core connection of the present invention.

FIG. 9 is a RTDDB data frame encoding layout in accordance with the present invention.

FIG. 10 is an A_PDU header layout for the RTDDB data frame encoding layout of FIG. 9.

FIG. 11 depicts the simple device logical references of an accelerator.

FIG. 12 is a layout of the data management of the present invention.

FIG. 13 depicts examples of published data frames of the present invention.

### DETAILED DESCRIPTION

While this invention is susceptible of embodiment in many different forms, there is shown in the drawings and will herein be described in detail a preferred embodiment of the invention with the understanding that the present disclosure is to be considered as an exemplification of the principles of the invention and is not intended to limit the broad aspect of the invention to the embodiments illustrated.

With reference to the Figures, Ethernet can be used as a device level 1 network (referred to herein as a Ethernet level 1 core) which can include sensor buses and focuses on the need to sample the physical manufacturing environment and to provide real-time data samples to a control level for decision making. Messaging application layer services, such as provided by Modbus, above the internet secured transport layer-internet network layer (TCP-IP) can be use as a basic solution. For the most demanding applications with high performance requirements, other solutions have been studied and evaluated. The real time distributed data base (RTDDB) solution, using multicasting capabilities of the internet user datagram protocol (UDP) transport layer, makes the best possible use of the Ethernet with high performance. It can be used in addition to, for example, Modbus.

For reference, the following is a glossary of terms used herein: (1) Modbus is a messaging application layer (Read/Write services) used as a basic applicative solution and also used for RTDDB configuration; (2) RTDDB is a new application layer services and protocol specified by the present specification providing efficient communication on Ethernet level 1 network using UDP multicasting capabilities; (3) Agents are network management configured devices; (4) a Manager is a device providing network management configuration to agents; (5) Simple devices usually are directly connected to the process (e.g., to perform measurements, input acquisition, to provide outputs, and the like). They also are agent devices. Examples are input/output (I/O) devices, drives and motor control centers (MCCs); (6) Intelligent devices are programmable. They may be managers. Examples are personal computers (PCs), programmable logic controllers (PLCs), specialized programmable devices, Human Machine Interfaces (HMIs) and gateways; Messaging exchanges are other non RTDDB exchanges in system; (7) Refreshment status is associated with a data sent by a device on the-network. It indicates that the data publisher is functioning. Refreshment is useful when communication still cyclically sends data on the network even if the data itself is invalid, because the data publisher is not functioning. Refreshment can use for example a timer, which is set each time the publisher writes data in the communication part of the device and wherein refreshment is valid until the timer expires; (8) Promptness status indicates that the data read from the communication system is not too old. Promptness is useful when the application part of the device still cyclically reads data from its communication part, even if the data itself is invalid, because the network is not functioning. Promptness status uses a timer, which is set each time the network writes data in the communication part of the device and wherein promptness is valid until the timer expires.

On Ethernet level 1 core network, the RTDDB solution is designed to fulfill following needs: intra-level 1 communications (e.g., used for distributed I/Os) and inter-level 1 communications (e.g., used for data exchanges between PCs, PLCs, and the like).

RTDDB communications can be mixed on the same Ethernet physical network, or can be separated depending on the application size and performance. RTDDB communications can also be mixed with, for example, Modbus communications.

Referring to FIG. 1 an example of intra-level communications is depicted. In an embodiment the number of devices 12 on the network 14 is typically between 10 and 50 with a maximum number under 256. The intelligent device 16 on the network sends cyclically to the simple devices 18 commands and the status of simple device outputs. Correspondingly, the simple devices 18 send back to the manager inputs, status, and other information as soon as a change occurs, on event and/or cyclic back-up. Direct communication between devices can also be provided (e.g., synchronization and clock). Intelligent devices can also participate in this direct communication.

Desirably, all RTDDB exchanges have high performance requirements. In an embodiment, the response time from one input change on any device to the corresponding output change on another device is preferred to be around a few ten milliseconds (ms), including input and output device processing, intelligent device processing and network exchanges wherein: processing delays inside simple devices may be a few ms; intelligent devices like PLCs use periodic task, with 15 ms typical period for fastest tasks; network delays may be a few ms, if Ethernet is not overloaded. Moreover, synchronization within this embodiment between output changes on several devices corresponding to one event is preferred to be around a few ms. Clock distribution within this embodiment provides capability for local event datation in devices with a 1 ms accuracy. This is especially useful in electrical distribution systems where each device has an accurate clock, synchronized by the network distributed clock, used for local time-stamping of events, which are afterwards centralized for discrimination and edition.

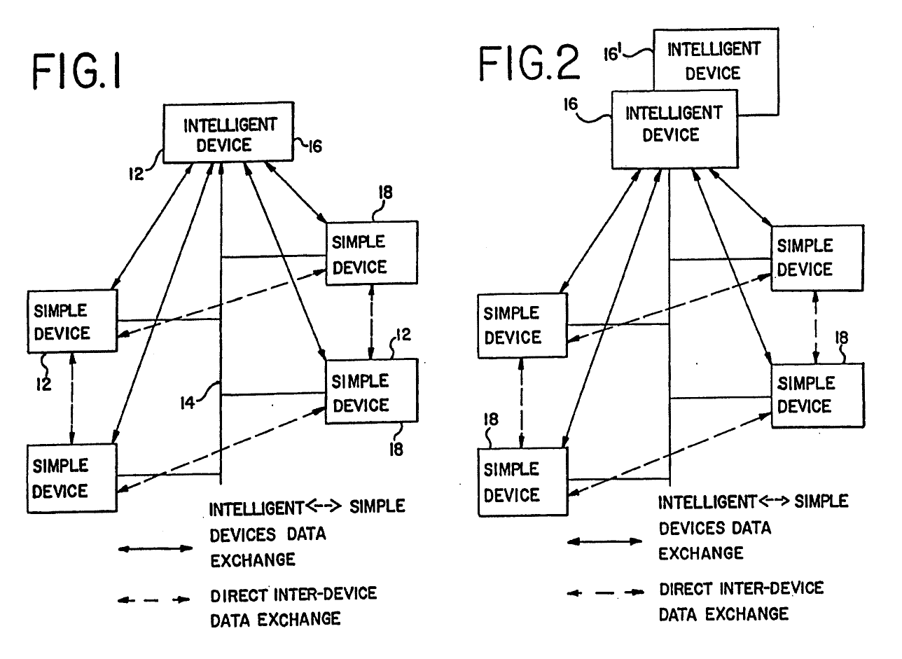

Referring-to FIG. 2, redundant intelligent devices 16,16′ can be used in another embodiment of an intra-level communications network. However, in this embodiment only one intelligent device is active at once, and sends commands to the simple devices 18, while other intelligent devices listen to traffic coming from agents.

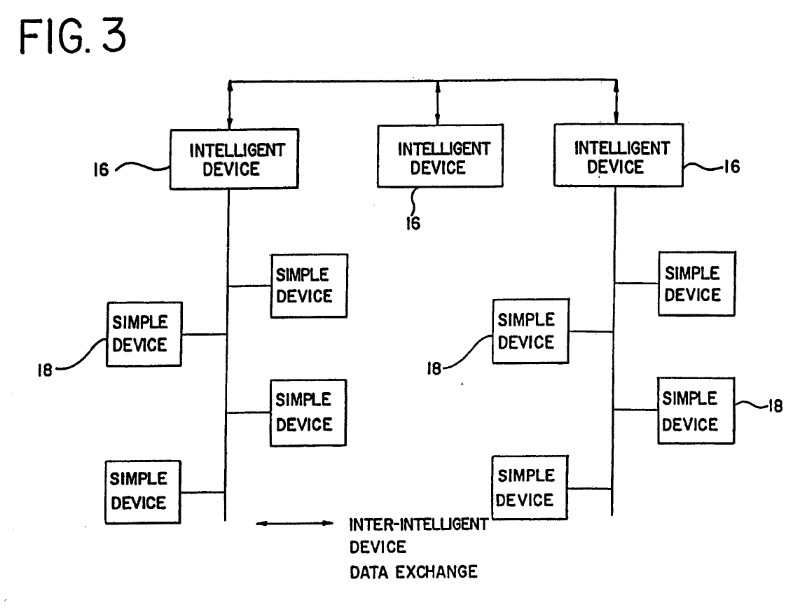

Referring to FIG. 3, in an embodiment each intelligent device 16 can have a cluster of up to 256 devices (including intelligent device), exchanging between them inter-level 1 communications. As indicated above, the intelligent devices 16 can be redundant. In a preferred embodiment, the typical number of intelligent devices 16 is between 4 and 16 with the maximum number being under 256.

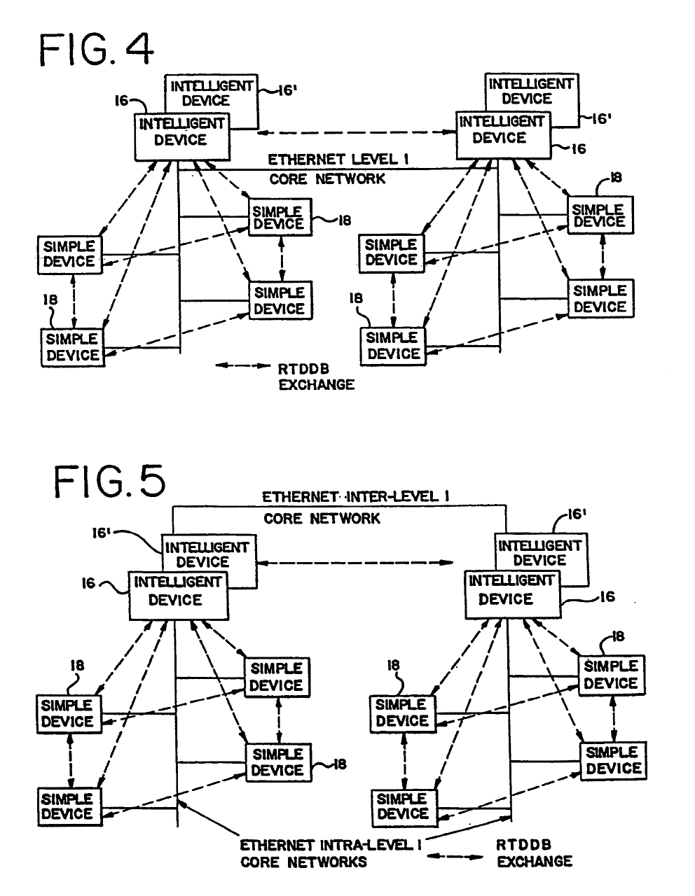

In the embodiment shown in FIG. 4, each intelligent device 16 sends cyclically to all other intelligent devices application data (e.g., used for synchronization between applicative tasks). The performance requirements are not so high as for inter-level 1 communications. It has been observed that typically, each intelligent device 16 will send 8 bytes of data every 40 ms, in systems having up to 32 intelligent devices.

Referring to FIG. 4, RTDDB intra and inter-level 1 communications can be mixed on the same Ethernet physical network. In addition, referring to FIG. 5, they can also be separated on different physical networks, as shown, wherein the choice is made taking into account application size and performance. It should be understood that in either cases, there is no RTDDB communications between simple devices of different clusters.

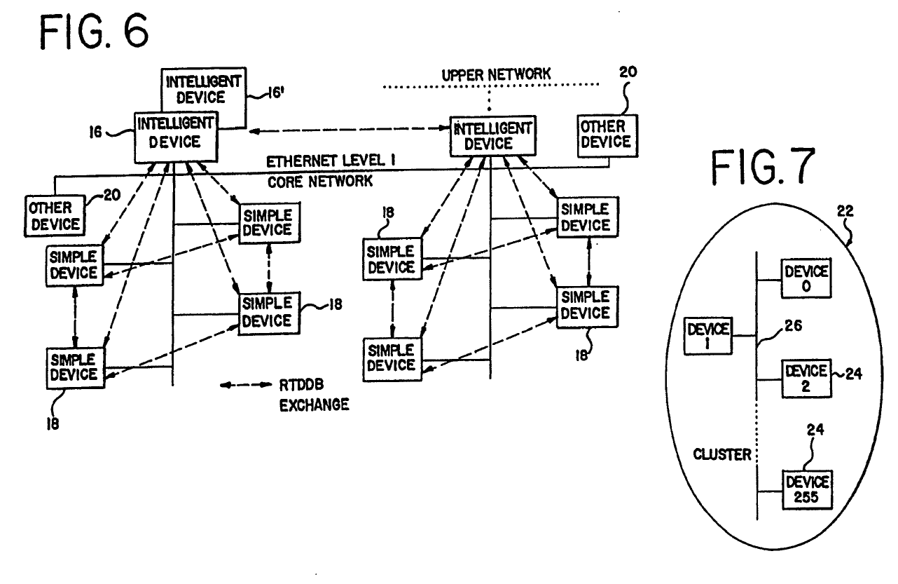

Referring to FIG. 6, RTDDB and Modbus communications can be mixed on the same Ethernet physical network along with any kind of other device. In this embodiment, messaging exchanges (Modbus) are not part of the RTDDB exchanges. Messaging exchanges are performed between any device in the networks, including: (1) exchanges with other devices 20 not participating in the RTDDB system, located on the level 1 network or on upper networks; and (2) other exchanges with simple 18 or intelligent devices 16 (e.g., for configuration and the like).

Referring to FIG. 7, within a preferred embodiment of a RTDDB system, clusters 22 (only one cluster shown) of up to 256 devices 24 can be defined. Each cluster 22 can contain any types of devices (Intelligent and/or simple). Multiple clusters are possible inside one RTDDB system, and some intelligent devices can belong to several clusters. As stated above, it should be understood that there is no RTDDB communication between devices of different clusters.

Inside each cluster 22, each device 24 publishes RTDDB frames. Frames are published either cyclically or when a change or an event occurs, at the publisher initiative. Frames are sent on the Ethernet network 26, using UDP and IP. Each frame may be sent to one device (using individual IP address), to a group of devices inside a cluster (using group IP multicast address), or to the cluster (using cluster IP multicast address). Groups can be dynamically defined.

In an embodiment, each frame contains one or several data and each device 22 subscribes to data it is interested in. The device in the cluster 22 is individually identified by a logical identification and each data is referenced. Means are also provided for a simple device to know very fast when a frame contains data which it is interested in. A RTDDB frame also contains a fault indication indicating when a fault occurs in the publisher. Each data has an associated refreshment status for indicating the state of the corresponding data producing part of the publisher and each subscriber can also control promptness of received data.

As described above, the RTDDB system can be used to answer intra-level 1 needs wherein the intelligent device (or the active intelligent device in a redundant system) cyclically multicasts a frame which contains individual data (commands, outputs) for a group of simple devices, using their group IP multicast address. The group is defined freely by the intelligent device, taking into account frame size limit.

Each of the simple devices decodes received valid multicast frames to extract data which has been addressed to it. For each data, the simple device controls its refreshment status and sets a promptness timer. When the refreshment status is false or when the timer times-out, the subscriber may enter in a specific operating mode (e.g., set outputs in fallback position).

Similarly, each simple device sends to the intelligent device(s) its published data (e.g., inputs, measures, and the like), using intelligent device IP address (which can be an individual address if there is only one intelligent device or a multicast address if redundant intelligent devices are used). Each simple device can also multicast on the network direct inter-device communication data, using the cluster IP multicast address. Each simple device published data can be sent when a change or an event occurs (e.g., on a digital input change), with a minimum inter-sending period, and/or cyclically. For example, a digital I/O device sends its input values when a change occurs, with a minimum inter-sending period of 10 ms, and cyclically for back-up every 100 ms. In another example, a drive sends the motor speed every 100 ms.

It should be noted that other addresses like sub-network broadcast address which are addressing more devices can be used (if only one cluster is used in the system), but should be used with careful attention because of potential performance impact due to all devices on the network receiving all sub-network broadcast frames and decoding them in software to know if they are interested in each frame. Using specific individual or multicast addresses is preferred because most of the non-interesting frames are filtered by the Ethernet component.

It should also be noted that simple device event driven sending is preferred to cyclic sending as the nominal solution whenever possible because it provides the best possible use of the Ethernet which was designed for event driven transmissions and the fastest response times.

Also as described above, the RTTDB system answers inter-level 1 needs wherein each intelligent device cyclically multicasts a frame which contains application data to be exchanged between intelligent devices, using intelligent device cluster IP multicast address. Each data has an associated refreshment status indicating the state of the corresponding producing part of the manager.

In addition, all intelligent devices interested in this data decode it, control its refreshment status and set a promptness timer. When the refreshment status is false or when the timer times-out, the subscriber may enter in a specific operating mode (e.g., local mode). Referring to FIG. 8, this figure depicts how the RTDDB system can be used to answer needs to mix intra and inter-level 1 communications (as described above).

The preferred aspects of the present invention with regard to initialization, data reference, and RTDDB frame encoding are described, in detail, below. With regard to initialization at each power-up before RTDDB initialization phase, each device preferably has acquired its IP parameters comprising: IP individual address; IP sub-network mask; IP default gateway address. These IP parameters can be acquired by, for example, a Bootstrap Protocol (BOOTP) request to a BOOTP server (e.g., for simple devices) or by local means (e.g., for managers having associated programming tools, HMI). Moreover, attention should be paid to have a coherent configuration in the system (unity of IP addresses, same IP sub-network mask), especially when using local means.

Next, RTDDB configuration information should be acquired comprising: Device logical identification; IP addresses to be used; Timing information; and all data should have a 2 byte reference.

Detailed configuration information contents, as well as how they are acquired, are typically specified in the product specification of each device. However, they are specified hereunder for the following devices: Simple devices used in intra-level 1 communications; Intelligent devices used in intra-level 1 communications; and Intelligent devices used in inter-level 1 communications.

Turning to configuration of the simple devices used in intra-level 1 communications, as soon as each simple device is ready to communicate using, for example, the Modbus protocol over TCP/IP, it waits for its manager (or a global configurator) writing significative values in RTDDB configuration registers before communicating using RTDDB protocol.

In an embodiment, the following registers can be written in each simple device, using Modbus services:

| Modbus | | | |
|---|---|---|---|
| Services | Configuration Registers | Offset in Hex | Size of Field |
| Read/Write | Logical identification | F201 | 1 word |
| Read/Write | Sending period | F202 | 1 word |
| Read/Write | Minimum inter-sending | F203 | 1 word |
| | period | | |
| Read/Write | Intelligent device IP | F204-F205 | 2 words |
| | address | | |
| Read/Write | Promptness period | F206 | 1 word |
| Read/Write | Receiving IP multicast | F207-F208 | 2 words |
| | address | | |
| Read/Write | Application specific | F209- to F3FF | Application |
| | registers | | specific |

With regard to the configuration resister, logical identification is one word at offset F201. This register can be read and written using, for example, Modbus commands, and the default value (at power up) is FF FFh (not configured for RTDDB). The significative RTDDB values are comprised between 0 and 255. As soon as a significant value is written in this register, the simple device starts using RTDDB. When other values (first byte not equal to 0) are written in this register, the simple device stops using RTDDB.

For the simple device first published data, its sending period is specified by the sending period register. Other periods for other published data can be specified in application specific registers. Preferably, the sending period is one word at offset F202. This register can be read and written using, for example, Modbus commands, and the default value (at power up) is FF FFh (no periodic broadcast). The sending period is in increments of 1 ms. Preferably, its minimum value is 5 ms.

The minimum inter-sending period for the simple device first published data is specified by the minimum inter-sending period register. Other periods for other published data can be specified in application specific registers. Minimum inter-sending period is one word at offset F203. This register can be read and written using, for example, Modbus commands, and the default value (at power up) is FF FFh (no sending on change). The minimum inter-sending period is in increments of 1 msec. Preferably, its minimum value is 10 ms.

Data are sent to the intelligent device(s) using this intelligent device IP address. The default value is the IP address of the first Modbus client of the agent (most often its manager). This value can be changed by a manager at any time. Individual address should be written in these registers, if there is no redundant intelligent device. Multicast address should be written in these registers, if redundant intelligent devices are used.

For the simple device first subscribed data its promptness period is specified by the promptness period register. Other periods for other subscribed data may be specified in application specific registers. Preferably, the promptness period is one word at offset F204. This register can be read and written using, for example, Modbus commands, and the default value (at power up) is 250 (250 ms). The promptness period is in increments of 1 ms. FF FFh value means no promptness control. Its minimum value preferably is 15 ms.

With regard to receiving IP multicast address, simple devices receive data on their own individual IP address, on the sub-network broadcast address and on the receiving IP multicast address applicable to a group of agents inside the cluster. There is no IP multicast address specified at power up. A new value can be taken into account only when RTDDB is stopped.

Turning to configuration of the intelligent devices used in intra-level 1 communications, after having acquired its IP parameters, each manager gets its configuration information, by local means (e.g., programming tools or HMI) or by requesting it to a global configurator. Desirably, the following configuration information is acquired to start RTDDB communications: (1) Intelligent device logical identification inside the intra-level 1 cluster; (2) IP addresses of the simple devices of the cluster and correspondence with their logical identifications; (3) Simple device group IP multicast addresses used to send frames to the simple device groups of the cluster; (4) Intelligent device group IP multicast address used to receive frames from the simple devices (if redundant managers are used); and (5) Cluster IP multicast address, if using direct inter-device communication.

Turning to configuration of the intelligent devices used in inter-level 1 communications, after having acquired its IP parameters, each manager gets its configuration information, by local means (e.g., programming tools or HMI) or by requesting it to a global configurator. Such configuration information preferably includes: (1) Intelligent device logical identification inside the inter-level 1 cluster; (2) Inter-level 1 IP multicast address to exchange data with other intelligent devices (default value is the sub-network broadcast address); and (3) lengths and periods of application data sent to other managers. Desirably, by default, only one application data (physical reference first byte 80h) of 8 bytes length is sent to other managers every 4 ms.

Each data inside the RTDDB system preferably has a 2 byte reference. In an embodiment, two types of reference can be used: Physical reference and logical reference. Physical reference is used where the second byte of the 2 byte reference is the device logical identification of one of the devices participating in the exchange. The first byte of the reference indicates which device data is addressed. Data syntax and semantic are specified by the device specification. Physical reference is very useful in the following exchanges, where this reference type provides automatic data reference configuration, as soon as device logical identifications are configured: (1) exchange with a simple device (e.g., data sent or received by a simple device), in which data can be sub-classified in applicative data (I/O values, measurements, commands, and the like) and system data (configuration, parameters, status, default, and the like); (2) data sent by an intelligent device to other intelligent devices.

Logical reference is where there is no reference to any device logical identification. Logical reference sub-types are defined as universal logical reference and dynamically assigned logical reference.

Universal logical reference is where data reference, syntax and semantic are specified by the present specification. This type of reference is useful for data which may be used in every system (e.g., clock and the like). Dynamically assigned logical reference is where any means can be used to assign reference to data, which can be of any type.

The following table specifies range of values reserved for each reference type:

| Reference Type | First Byte | Second Byte | Use | Use Example |
|---|---|---|---|---|
| Physical | 01h to 3Fh odd | Simple device | Applicative data | Intelligent device --> |
| reference | values | logical | sent to a simple | Simple device |
| | | identification | device | in intra-level 1 |
| | | | | communication |
| | 41h to 7Fh odd | Simple device | System data sent | Intelligent device --> |
| | values | logical | to a simple | Simple device |
| | | identification | device | in intra-level 1 |
| | | | | communication |
| | 00h to 3Eh even | Simple device | Applicative data | Simple device --> |
| | values | logical | sent by a simple | Intelligent device |
| | | identification | device | in intra-level 1 |
| | | | | communication |
| | 40H to 7Eh even | Simple device | System data sent | Simple device --> |
| | values | logical | by a simple | Intelligent device |
| | | identification | device | in intra-level 1 |
| | | | | communication |
| | 80 h to 8Fh | Intelligent device | Data sent by an | Intelligent device --> |
| | | logical | intelligent | Intelligent devices |
| | | identification | device | in inter-level |
| | | | | communication |
| Logical | 9000h to 9FFFh | 9000h to 9FFFh | Data with | Direct inter-device |
| reference | | | universal | communication in |
| | | | reference | intra or inter-level |
| | | | (clock . . .) | 1 communication |
| Logical | A000h to FFFFh | A000h to FFFFh | Data with | Any |
| reference | | | dynamically | communication |
| | | | assigned | |
| | | | reference | |

It should be noted that different data inside a cluster should have different data reference. Same data reference can be used for data of different clusters inside a RTDDB system.

Turning to the subject of RTDDB frame encoding, each device can publish RTDDB frames that are sent on the Ethernet network using UDP and IP. The frames are published either cyclically or when a change or an event occurs. Each frame can be sent to one device using individual IP address, to a group of devices using inside the network segment using group IP multicast address, or to the network segment using sub-network IP broadcast address. Further, groups can be dynamically defined.

As indicated above, each frame contains one or several data and each device subscribes to data it is interested in. Moreover, each device on the network segment is preferably identified by a logical identification and each data is referenced.

A fault indication is provided by each frame for indicating when a fault occurs in the publisher. Furthermore, each data has an associated refreshment status, which can indicate the state of the corresponding data producing part of the publisher. Each subscriber can control promptness of received data.

A network manager, using messaging services or other communication services makes an RTDDB configuration of each device. RTDDB configuration includes device logical identifications, data references, timing information and IP multicast addresses. Preferably, all devices participating in the RTDDB system have the same IP sub-network address. Also, it is desirable that no router be used inside the RTDDB system.

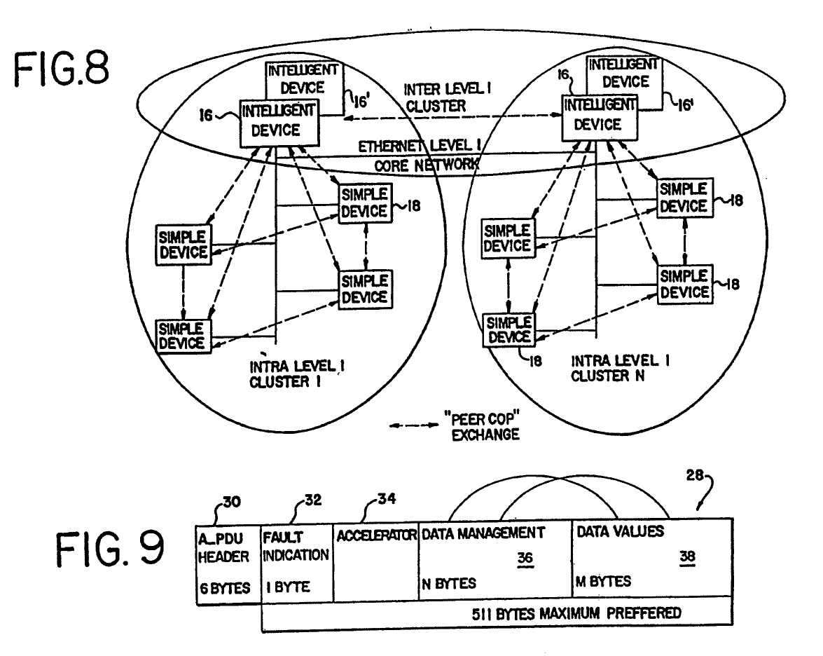

Turning to FIG. 9, the application part 28 of the published frame is composed of five different fields: (1) A_PDU header 30; (2) Fault Indication 32; (3) Accelerator 34; (4) Data management field 36; (5) and Data value field 38.

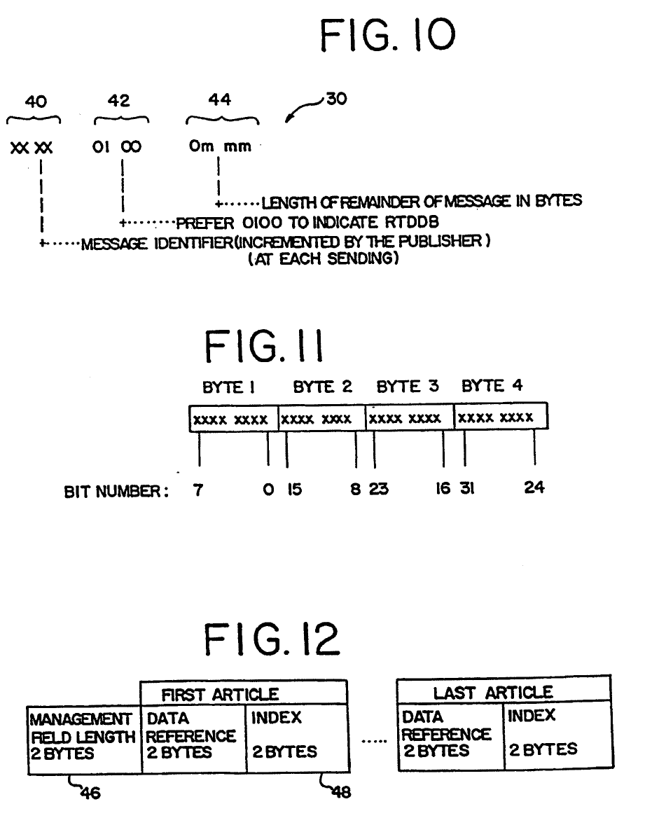

FIG. 10 shows the preferred embodiment of A_PDU header 30 having a message indicator 40, RTDDB indicator 42, and message length indicator 44.

Regarding fault indication, each frame contains a fault indication indicating when a fault occurs in the publisher device. A value different from 0 indicates a fault. The encoding of this byte is application specific. This indication can be used to indicate very fast to other devices participating in the application that a fault occurs (e.g., fast indication of a watch-dog fault in a simple device, sent to the intelligent device, or fast indication of an intelligent device in local mode, sent to other intelligent devices).

The accelerator field 34 is used to provide capability to know very fast and easily if data may be addressed to a device in the rest of the frame. This accelerator is especially useful in simple devices. This field is preferably a 5 byte synthesis of all the data references included in the frame:

| | |
|---|---|
| Data reference types 1 byte | Simple device logical references 4 bytes |

The first byte, Data reference types, is a string of 8 bits indicating with types of data references are used in the frame, based-on the first byte of each data reference:

| Bits set to 1 in data | Indicating that at least one data |
|---|---|
| reference types byte | reference first byte has a value: |
| Bit 7 | 01h to 3Fh odd values |
| Bit6 | 41h to 7Fh odd values |
| Bit5 | 00h to 3Eh even values |
| Bit4 | 40h to 7Eh even values |
| Bit3 | 80h to 8Fh |
| Bit2 | 90h to 9Fh |
| Bit1 | A0h to FFh |

Bit0is set to 0.

If bit7 or bit6 of previous byte is set to 1, the four following bytes (byte1 to byte4 shown in FIG. 11) are a string of 32 bits, indicating which logical identification group are addressed (corresponding bits are set to 1). For example, bit0 indicates that at least one device having logical identification 0 to 7 is addressed, bit1 indicates that at least one device having logical identification 8 to 15 is addressed, . . . bit31 indicated that at least one device having logical identification 248 to 255 is addressed. If bit7 and bit6 of previous byte are set to 0, byte1 to byte4 are set to 0.

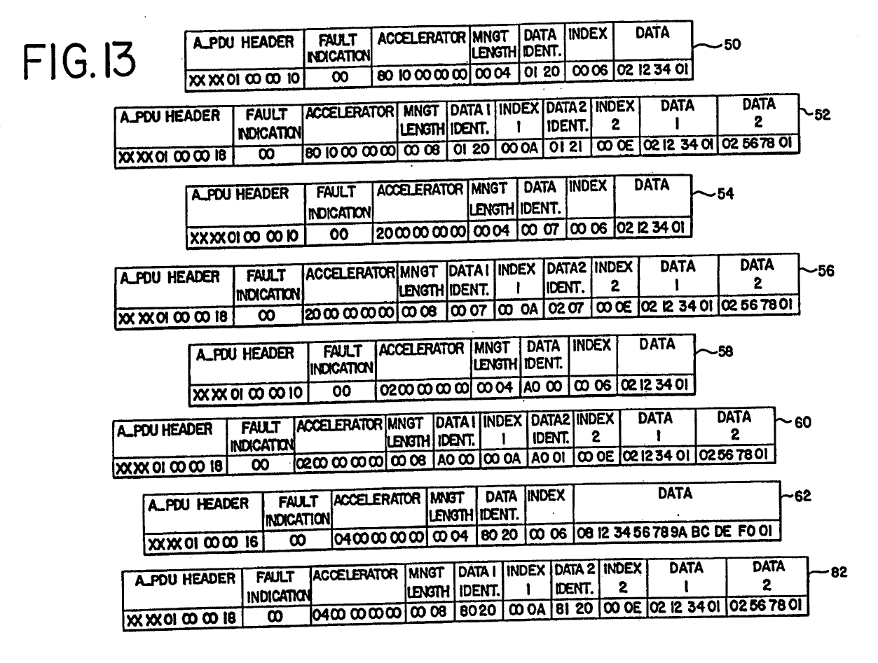

The data management field preferably has the structure identified in FIG. 12. The management field length 46 gives the length of the remainder of the data management field in bytes. For each data, an index (2 bytes word 48) gives the position of the data value: This is the byte number since the beginning of the data management field and before the first data byte (not included).

Preferably, each data has the following structure: n d 1 . . . dn rf, wherein n equals the length of data in bytes (limiting the data length to 255 bytes), d 1 equals the value of the first byte (first data byte), dn equals the value of the last byte (last data byte), rf equals the refreshment status which may indicate the state of the corresponding data producing part of the publisher: xxxx xxx0 when invalid, and xxxx xxx1 when valid, where x means application specific. Moreover, each subscriber can control promptness of received data.

FIG. 13 depict examples of published frames. In particular, reference number 50 depicts an Application Layer frame to send to one simple device, at logical identification 32, one fresh data of one word with physical reference first byte 01, without any fault. Reference number 52 shows an Application Layer frame to send to two simple devices, at logical identifications 32 and 33, one fresh data of one word with physical reference first byte 01, without any fault. Reference number 54 depicts an Application Layer frame to send by a simple device, at logical identification 07, one fresh data of one word with physical reference first byte 00, without any fault. Reference number 56 illustrates an Application Layer frame to send by a simple device, at logical identification 07, two fresh data of one word with physical reference first byte 00 and 02, without any fault.

Reference number 58 illustrates an Application Layer frame to send by a device one fresh data of one word with logical reference A000h, without any fault. Reference number 60 depicts an Application Layer frame to send by a device two fresh data of one word with logical reference A000h and A0001h, without any fault. FIG. 62 shows an Application Layer frame to send by an intelligent device at logical identification 32, to other intelligent devices, one fresh default data of 8 bytes with physical reference first byte 80, without any fault. FIG. 82 depicts an Application Layer frame to send by an intelligent device at logical identification 32, to other intelligent devices, two fresh data of one word with physical reference first byte 80 and 81, without any fault.

It should be noted that this structure provides addressing capability for 32 data, each one having up to 4 application words, (application frame length of 458 bytes, without A_PDU), or 8 data with 16 application words and 24 data with 1 application word (total frame length of 504 bytes, without A_PDU).

In an embodiment, a communications adapter can be provided for interfacing between a transfer body, which can be a part of the simple device, and the communications network having the simple devices and each intelligent device connected thereto. The transfer body includes a plurality of transfer registers for communicating data relating to field devices, and an identification register for identifying the data relating to the field devices. Moreover, an interface portion is provided having an identification port communicating with the identification register, a transfer port communicating with the transfer registers, wherein the transfer body is adapted to directly attach to and communicate with each intelligent device through the interface portion. Furthermore, the communications adapter can be removably attached to the transfer body through the transfer-port and the identification port, wherein the communications adapter is configured to communicate with a specific type of intelligent device. Such a communication adapter is disclosed in, for example, U.S. patent application Ser. No. 09/036,565, filed Mar. 9, 1998, and incorporated herein by reference.

While the specific embodiments have been illustrated and described, numerous modifications come to mind without significantly departing from the spirit of the invention and the scope of protection is only limited by the scope of the accompanying claims.

1. A communication system for communication within a control system, the communication system comprising:
a plurality of devices connected to an industrial communications network, each device configured for real time data transfer and being adapted to directly exchange data with the other devices;
one of the plurality of devices configured for sending a frame on the network using internet user datagram protocol transport layer and internet protocol, the frame including an accelerator field comprising a string of bits, wherein each of at least a plurality of the bits of the string of bits are associated with a different plurality of logical device identifications, whereby the value of each of the plurality of bits indicates whether the frame is associated with the corresponding plurality of logical device identifications so that a device may determine quickly if data may be addressed to that device in the rest of the frame; and
at least one other of the plurality of devices, if interested upon review of the accelerator field, configured for receiving the frame from the network.

2. The communication system of claim 1 wherein the one of the devices is configured for sending the frame to a device connected to the network using individual internet protocol address.

3. The communication system of claim 1 wherein the one of the devices is configured for sending the frame to a group of devices connected to the network using group internet protocol multicast address.

4. The communication system of claim 1, wherein the one of the devices is configured for sending the frame to all devices connected to the network using cluster internet protocol multicast address.

5. The communication system of claim 1 wherein the one of the devices is configured for publishing the frame cyclically.

6. The communication system of claim 1 wherein the one of the devices is configured for publishing the frame when a predetermined event occurs.

7. The communication system of claim 1 wherein the frame contains data and some of the devices subscribe to the data.

8. The communication system of claim 1 wherein the at least one other device configured to receive the frame is connected to the network having a refreshment status and a promptness timer responsive to data received.

9. The communication system of claim 1 wherein the frame includes an indication field, and a management field for decoding the frame.

10. The communication system of claim 1 wherein the devices are initially set to a default configuration for minimizing communication on the network.

11. A communication system for communication within a control system, the communication system comprising:
a plurality of simple devices connected to an intra-level industrial communications network, each simple device of the plurality of simple devices being adapted to directly exchange data with the other simple devices of the plurality of simple devices;
at least one intelligent device connected to the intra-level industrial communications network, each of the at least one intelligent device being adapted to directly exchange data with each simple device on the intra-level industrial communications network; and
one of the devices being adapted to send a frame on the network using internet datagram transport layer and internet protocol.

12. A communication system for communication within a control system, the communication system comprising:
a plurality of input/output devices connected to a first intra-level communications network, each input/output device being adapted to directly exchange data with the other input/output devices within the first intra-level communications network;
communications network, each programmable logic controller being adapted to directly exchange data with each input/output device on the first intra-level communications network;
a plurality of input/output devices connected to a second intra-level communications network, each input/output device being adapted to directly exchange data with the other input/output devices within the second intra-level communications network;
at least one programmable logic controller connected to the second intra-level communications network, each programmable logic controller being adapted to directly exchange data with each input/output device on the second intra-level communications network; and,
an intra-level core connector for directly connecting the first intra-level communications network to the second intra-level communications network.

13. The communication system of claim 12 wherein one of the devices on the first intra-level network is configured to send a frame on the first intra-level network using internet datagram transport layer and internet protocol.

14. The communication system of claim 13 wherein the one of the devices on the first intra-level network is configured to send the frame to a device connected to the first infra-level network using individual internet protocol address.

15. The communication system of claim 13 wherein the one of the devices on the first intra-level network is configured to send the frame to a group of devices connected to the first intra-level network using group internet protocol multicast address.

16. The communication system of claim 13 wherein the one of the devices on the first intra-level network is configured to send the frame to all devices connected to the first intra-level network using cluster internet protocol multicast address.

17. The communication system of claim 13 wherein the one of the devices on the first intra-level network is configured to publish the frame cyclically.

18. The communication system of claim 13 wherein the one of the devices on the first intra-level network is configured to publish the frame when a predetermined event occurs.

19. The communication system of claim 13 wherein the frame contains data and some of the devices connected to the first intra-level network subscribe to the data.

20. The communication system of claim 13 wherein a device connected to the first intra-level network having a refreshment status and a promptness timer responsive to data received is configured to receive the frame.

21.-36. (canceled)
